(19) United States
(12) Patent Application Publication
(10) Pub. No.: US 2010/0169756 A1
(43) Pub. Date: Jul. 1, 2010

(54) AUTOMATED BOOKMARKING

(75) Inventors: Francesco Bonchi, Barcelona (ES); Athellina Athsani, San Jose, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/345,293

(22) Filed: Dec. 29, 2008

(51) Int. Cl. G06F 17/00

(52) U.S. Cl. 715/206

(57) ABSTRACT

The subject matter disclosed herein relates to automatically generating bookmarks associating user accounts with individual links based at least in part on tracked user access data.

### BACKGROUND

1. Field

The subject matter disclosed herein relates to data processing, and more particularly to methods and apparatuses that may be implemented to automatically generate bookmarks associating user accounts with individual links based at least in part on tracked user access data through one or more computing platforms and/or other like devices.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided, which allow for the copious amounts of information to be searched through in an efficient manner. For example, service providers may allow for users to search the World Wide Web or other like networks using search engines. Similar tools or services may allow for one or more databases or other like data repositories to be searched. With so much information being available, there is a continuing need for methods and systems that allow for pertinent information to be analyzed in an efficient manner.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a process for automatically generating bookmarks associating user accounts with individual links based at least in part on tracked user access data in accordance with one or more exemplary embodiments.

FIG. 2 is a diagram illustrating an example web browser display in accordance with one or more exemplary embodiments.

FIG. 3 is a diagram illustrating an example web browser display in accordance with one or more exemplary embodiments.

FIG. 4 is a diagram illustrating an example web browser display in accordance with one or more exemplary embodiments.

FIG. 5 is a diagram illustrating an example web browser display in accordance with one or more exemplary embodiments.

FIG. 6 is a block diagram illustrating an embodiment of a computing environment system in accordance with one or more exemplary embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, process, components and/or circuits have not been described in detail.

As will be described in greater detail below, methods and apparatuses may be implemented to automatically generate bookmarks associating user accounts with individual links based at least in part on tracked user access data. Such automatically generate bookmarks may be utilized to simplify and/or streamline Internet browsing for users. For example, site visits and/or query behavior associated with user accounts may be utilized to automatically and/or contextually track, store, surface and/or maintain the user's site visit and/or query history in a myriad of bookmarking and/or other like options. Such site visit and/or query behavior may track, store and/or maintain clicked through links; those sites frequently visited, that were entered as a search query; and/or links and/or contextual information associated with visited links.

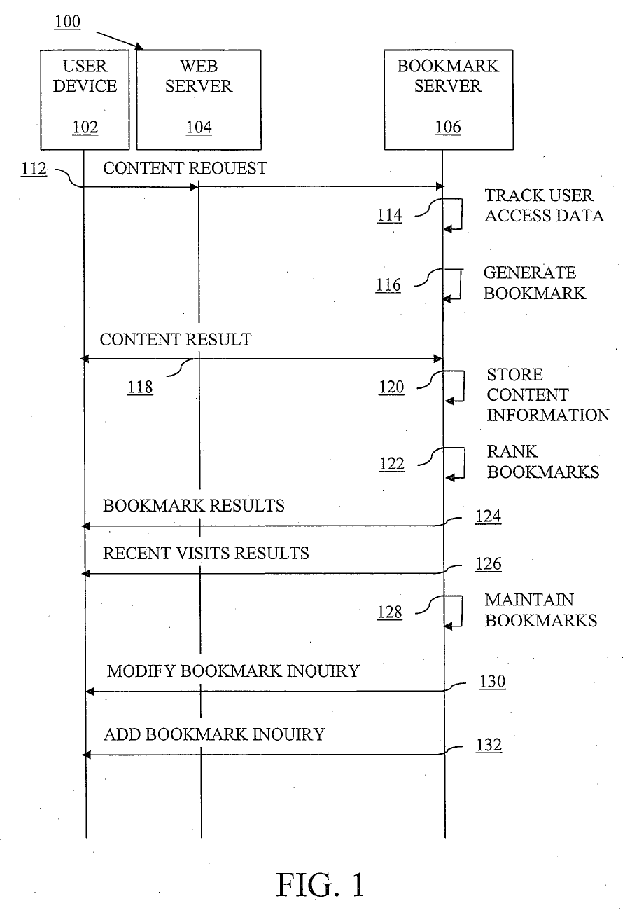

Referring to FIG. 1, a process 100 is illustrated for automatically generating bookmarks associating user accounts with individual links based at least in part on tracked user access data in accordance with one or more exemplary embodiments. As used herein, the term “link” and/or the like may refer to a coded address, such as a Uniform Resource Locator (URL), and/or the like. Additionally, although process 100, as shown in FIG. 1, comprises one particular order of actions, the order in which the actions are presented does not necessarily limit claimed subject matter to any particular order. Likewise, intervening actions not shown in FIG. 1 and/or additional actions not shown in FIG. 1 may be employed and/or actions shown in FIG. 1 may be eliminated, without departing from the scope of claimed subject matter. Process 100 depicted in FIG. 1 may in alternative embodiments be implemented in software, hardware, and/or firmware, and may comprise discrete operations.

As illustrated, process 100 may govern certain operations of a bookmark server 106 associated with a web server 104 and/or a user device 102 via a network (not shown). Web server 104 may be capable of delivering content items to user device 102. Additionally or alternatively, web server 104 may be associated with a search engine (not shown) that may be capable of searching for content items of interest. In such a case, such a search engine may communicate with/over a network to access and/or search available information sources. By way of example, but not limitation, such a network may include a local area network, a wide area network, the like, and/or combinations thereof, such as, for example, the Internet. Additionally or alternatively, such a search engine and its constituent components may be deployed across a network in a distributed manner, whereby components may be duplicated and/or strategically placed throughout the network for increased performance.

As mentioned above, web server 104 may be associated with a search engine (not shown). Such a search engine may include multiple components. For example, a search engine may include a ranking component and/or a crawler component. Additionally or alternatively, a search engine also may include various additional components, without departing from the scope of claimed subject matter.

At block 112, a content request may be provided to web server 104 from user device 102. Such a content request may include a search query, an accessed link, a request for a specific Uniform Resource Locator (URL), and/or the like. At block 118, a content result may be retrieved by web server 104 based at least in part on the content request from user device 102. In a case where the content request was a search query, a search engine associated with web server 104 may perform a search on the Internet for content items such as electronic documents that meet the search query to prepare a search result. For example, in response to such a search query, a search engine may produce a content result that may include multiple electronic documents ranked based at least in part upon relevance to the search query according to scoring criteria used by the search engine.

As used herein, the term “electronic document” may include any information in a digital format that may be perceived by a user if displayed by a digital device, such as, for example, a computing platform. For one or more embodiments, an electronic document may comprise a web page coded in a markup language, such as, for example, HTML (hypertext markup language). However, the scope of claimed subject matter is not limited in this respect. Also, for one or more embodiments, the electronic document may comprise a number of elements. The elements in one or more embodiments may comprise text, for example, as may be displayed on a web page. Also, for one or more embodiments, the elements may comprise a graphical object, such as, for example, a digital image. Unless specifically stated, an electronic document may refer to either the source code for a particular web page or the web page itself. Each web page may contain embedded references to images, audio, video, other web documents, etc. One common type of reference used to identify and locate resources on the web is a URL.

At block 114, user access data may be tracked by bookmark database 106. For example, user access data may be tracked based at least in part on site visits and/or queries associated with a user account. As used herein, the term “user account” and/or the like may refer to an individual user, a class of users such as a group and/or organization that may share a given user access account, a user device, a class user devices that may share a given user access account, and/or the like, and/or combinations thereof. As used herein, the term “visit” and/or the like may refer to loading, accessing, and/or fetching, all and/or a portion of an electronic document and/or the like. As used herein, the term “track” and/or the like may refer to contemporaneously monitoring and/or collecting of live user access data, accessing stored user access data, and/or the like, and/or combinations thereof. Such user access data may include content requests from user device 102, discussed above with respect to block 112. As used herein, the term “user access data” is meant to include information associated with behavior of a user account including a current network location, a current query, frequency of visits, duration of visit, recent visits, contextual information, and/or the like. Wherein such frequency refers to a number of visits no periodicity, such time may be based on active user account time, calendar time, and/or the like. In some embodiments, such a current network location may refer to a navagatable and/or accessible logical location within the data available within the network, which may include a current Internet location. As used herein, the term “recent” and/or “recency” may refer to a quantification of the last time an electronic document, such as a web page, was visited.

At block 116, one or more bookmarks may be automatically generated. For example, such bookmarks may be automatically generated based at least in part on tracked user access data. For example, such tracked user access data, may include frequency of visits. In such a case, such bookmarks may be automatically generated based at least in part on tracked user access data that includes frequency of visits. In such a case, bookmarks may be automatically generated for location information, such as URLs, in cases where the frequency of visits by a user account to a given electronic document is sufficient to meet and/or exceed a threshold value. As used herein, the term “bookmark” is meant to include network-related location information, such as URLs, that has been stored to facilitate a user cataloging and/or later retrieving an electronic document by accessing such location information. Such bookmarks may also be referred to as (and/or include) Internet bookmarks, Internet shortcuts, favorites, and/or the like.

At block 118, a content result may be retrieved by web server 104 based at least in part on the content request from user device 102. Such a content result may be received by bookmark server 108. At block 120, information associate with such content results may be stored by bookmark server 108. For example, bookmark server 108 may store information associate with such content results in a separate database (not shown). Such information associate with such content results may include URLs and/or contextual information associated with electronic documents returned in the content results. Additionally or alternatively, a content result may be utilized to update user access data. For example, a content result may provide information regarding a current network location, frequency of visits, duration of visit, recent visits, and/or the like; and/or may provide contextual information that may be utilized to identify contextually relevant links based on a subsequent query.

At block 122, one or more of the automatically generated bookmarks may be ranked (e.g., ordered/arranged in some manner). For example, such bookmarks may be ranked by bookmark server 108 based at least in part on a current network location of an user account, a current query of an user account, frequency of visit, and/or duration of last visit. In one example, bookmark server 108 may have received user access data including a current network location and/or a current query at block 112 and/or block 118. At block 124, one or more of such bookmarks may be sent to a user account device 102. As used herein the term “sent,” “send,” “sending,” and or the like may include sending, surfacing, accessing, sharing the information, and/or otherwise making available, and/or the like. For example, bookmark server 108 may send bookmarks to user device 102 based at least in part on the ranked bookmarks.

Additionally or alternatively, at block 126, additional links may be sent to a user account device 102. As used herein, the term “additional links” may refer to non-bookmarked links associated with a user account based at least in part on tracked user access data, such as where such tracked user access data includes recency of visits, duration of last visit, and/or relevancy to a query. One difference between the bookmarks and additional links, as described herein, is that the bookmarks may be general site/page location identified based at least in part on frequency of visit, while additional links may be general site/page location identified based at least in part on recency of visit. For example, such additional links may include links that have been recently visited by a user account, but may not be bookmarked (e.g., due to a lack of frequency of visits, etc.). Bookmark server 108 may rank and/or surface non-bookmarked additional links to user device based at least in part on a current network location and/or a current query, similar to the actions described above with respect to blocks 122 and 124. Additionally or alternatively, ranking of bookmarks and/or additional links may be performed by a search engine (not shown) associated with web server 104.

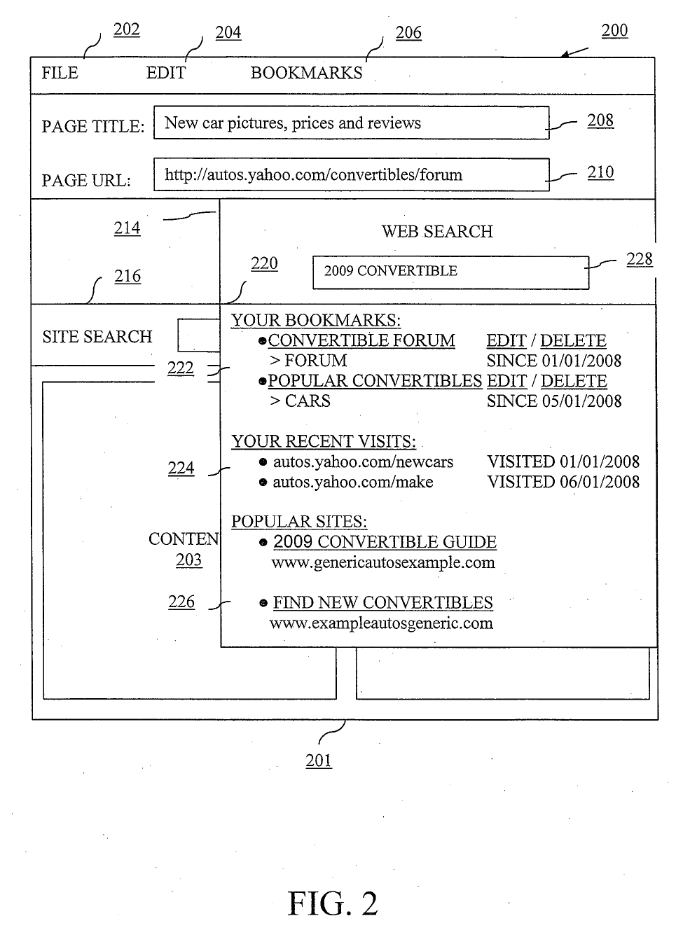

As will be described in greater detail below with respect to the examples illustrated in FIGS. 2-4, all or portions of sent bookmarks from block 124, sent additional links from block 126, and/or content results (such as a ranked search results) from block 118 may be displayed at user device 102.

Referring to FIG. 2, a web browser display 200 is illustrated in accordance with one or more exemplary embodiments. The display may be viewed by a user on an electronic device such as, for example, a computing platform. For this example, browser display 200 may be generated by a web browser application that facilitates navigation of the web by the user, such as at user device 102 (FIG. 1). The web browser may display any of a very wide range of information from a very wide range of web sites located across the web. For this example, browser display 200 depicts a web page 201 from a Yahoo!® web site including content 203 regarding automobiles. Of course, this is merely an example of the types of information that may be displayed via the web browser, and the scope of claimed subject matter is not limited in this respect.

For this example, web browser display 200 may include a file button 202, an edit button 204, a bookmark button 206, and/or the like. File button 202, an edit button 204, a bookmark button 206 may be included in a toolbar of web browser display 200. A page title 208 to identify the subject matter of the current web page 201 and/or a page URL 210 to identify the address of the current web page 201 may be included in web browser display 200. A web search field 214 may be included in a toolbar of web browser display 200 and/or may be included as an aspect of a given web page 201. Such a web search field 214 may be utilized to access a search engine for an Internet search of the World Wide Web and/or the like. Additionally or alternatively, a site search field 216 may be included as an aspect of a given web page 201. Such a site search field 216 may be utilized to access a search engine for an Internet search of electronic documents associated with the current web page 201.

As mentioned above, all or portions of sent bookmarks from block 124 (FIG. 1), sent additional links from block 126(FIG. 1), and/or content results (such as a ranked search results) from block 118 (FIG. 1) may be displayed at user device 102 (FIG. 1). Such bookmarks, additional links, and/or content results (such as a ranked search results) may be displayed in conjunction with a menu (not shown) associated with bookmark button 206 of web browser display 200, displayed in a pop-up window (not shown) over web browser display 200, and/or displayed within web page 201 as illustrated in FIG. 2.

In the example illustrated in listing 220, bookmarks 222, additional links 224, and/or content results 226 (including ranked search results) may be displayed within web page 201. As discussed above at block 116 (FIG. 1), bookmarks 222 may be automatically generated for location information, such as URLs, in cases where the frequency of visits by an user account to a given electronic document is sufficient to meet and/or exceed a threshold value. In response to a content request, such as a search query, an accessed link, a request for a specific URL, and/or the like, bookmarks 222, additional links 224, and/or content results 226 (including ranked search results) may be displayed within web page 201. As illustrated here, bookmarks 222 may be displayed within web page 201. As discussed above at block 124 (FIG. 1), bookmarks 222 may be ranked by bookmark server 108 based at least in part on a current network location of an user account and/or a current query of an user account. In the present illustration, bookmarks 222 have been ranked for display base at least in part on a current query 228 of a user account. For example, current query 228 may be utilized to determine contextual relevancy of the bookmarks to 222. In such a case, bookmarks 222 may be ranked by bookmark server 108 based at least in part on a review of the user access data. For example, a current query 228 for “2009 CONVERTIBLE” may return bookmarks 222 related to the query such as “CONVERTIBLE FORUM”, “POPULAR CONVERTIBLES”, and/or the like.

Additionally or alternatively, as illustrated here, additional links 224 may be displayed within web page 201. Such additional links 224 may include links that have been recently visited by a user account, but may not be bookmarked due to a lack of frequency of visits. As discussed above at block 126 (FIG. 1), additional links 224 may be ranked by bookmark server 108 based at least in part on a current network location of an user account and/or a current query of an user account. In the present illustration, additional links 224 have been ranked for display base at least in part on a current query 228 of a user account. For example, a current query 228 for “2009 CONVERTIBLE” may return additional links 224 related to the query such as “autos.yahoo.com/newcars”, “autos.yahoo.com/make”, and/or the like.

Additionally or alternatively, as illustrated here, content results 226 may be displayed within web page 201. Such content results 226 may include links from a ranked search result generated by a search engine (not shown) associated with web server 104 (FIG. 1). As discussed above at block 118 (FIG. 1), content results 226 (including ranked search results) may be ranked by search engine (not shown) associated with web server 104 (FIG. 1) based at least in part on a current network location of an user account and/or a current query of an user account. In the present illustration, content results 226 (including ranked search results) have been ranked for display base at least in part on a current query 228 of a user account. For example, a current query 228 for “2009 CONVERTIBLE” may return content results 226 (including ranked search results) related to the query such as “www.genericautosexample.com”, “www.exampleautosgeneric.com”, and/or the like.

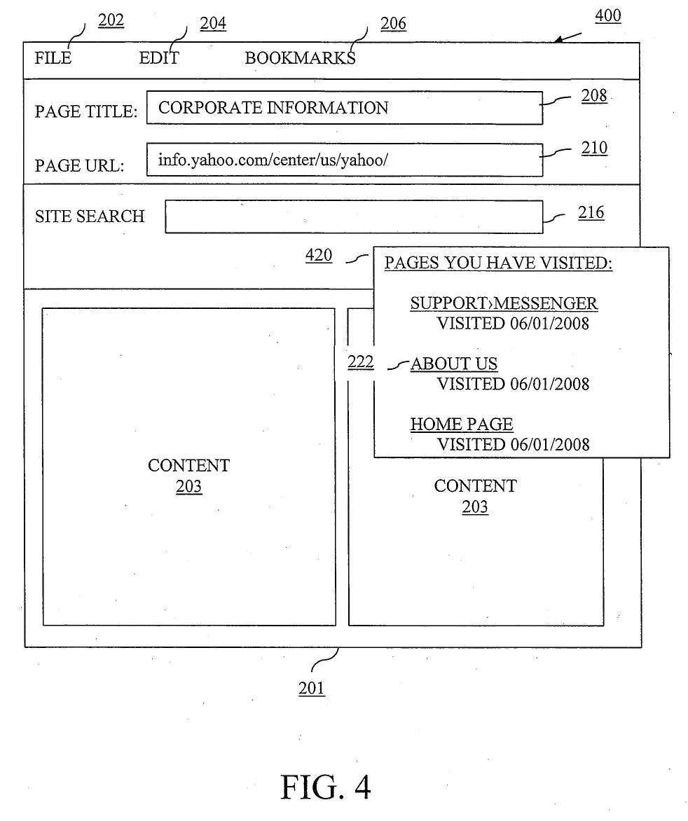

Referring to FIG. 4, a web browser display 400 is illustrated in accordance with one or more exemplary embodiments. In the example illustrated here, a pop-up window 420 may display bookmarks, additional links, and/or content results (including ranked search results). As discussed above at block 124 (FIG. 1), bookmarks 222 may be ranked by bookmark server 108 based at least in part on a current network location of an user account and/or a current query of an user account. In the present illustration, bookmarks 222 have been ranked for display base at least in part on a current location 210 of a user account. For example, a current location 210 of “info.yahoo.com/center/us/yahoo/” may return bookmarks 222 related to the current location. For example, such bookmarks 222 may be related to the current location as sub-pages of a current location, such as a “SUPPORT” page, an “ABOUT US” page, and/or the like. In another example, such bookmarks 222 may be related to the current location based at least in part on browsing patterns of a given user that may indicate a probable sequence of web page viewings. In such a case, browsing patterns of a given user that may indicate a probable sequence of web page viewings indicating that from “info.yahoo.com/center/us/yahoo/” a user may often go next to a “SUPPORT” page, an “ABOUT US” page, and/or the like. Such a sequence of web page viewings may be formed based on an analysis of bookmarks 222 associated with sub-pages of a current location, as illustrated here, or may be formed based on any other bookmarks 222.

Referring back to FIG. 1, at block 128, bookmarks generated at block 118 may be maintained. For example, bookmark server 108 may determine if an period of inactivity associated with one or more of said bookmarks has elapsed based at least in part on tracked user access data. As used herein, “period of inactivity” and/or “inactivity” refers to an amount of time from the last visit to an electronic document associated with a bookmark. Such maintenance may involve bookmark server 108 automatically removing one or more the bookmarks based at least in part on such a determined period of inactivity.

Additionally or alternatively, at block 130, bookmark server 108 send a request for input to said user account regarding modification of one or more of the bookmarks. In one example, such a request regarding modification of bookmarks may include a request to remove a bookmark that may be sent based at least in part on a determined period of inactivity. Additionally or alternatively, such a modification may include a request for input regarding changing settings associated with a given bookmark (such as changing a category and/or folder associated with such a bookmark), and/or may include a request for input regarding maintaining such a bookmark, and/or the like.

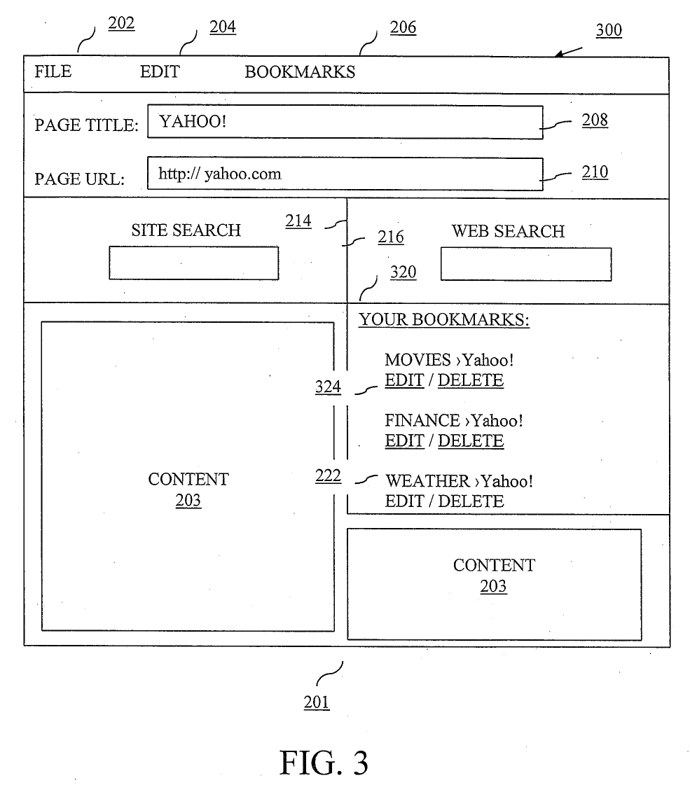

Referring to FIG. 3, a web browser display 300 is illustrated in accordance with one or more exemplary embodiments. As illustrated here, bookmarks 222 may be associated with maintenance buttons 324. Such maintenance buttons 324 may be utilized to allow a user to edit settings associated with a bookmark 222 (such as a subject matter category and/or a folder location) and/or to delete such a bookmark 222. In one example, as discussed above at block 130 (FIG. 1), a request to remove a bookmark 222 may be sent to a user device 102 (FIG. 1) based at least in part on a determined period of inactivity. In such a case, information regarding the number/frequency of visits and/or the most recent visit may be supplied along with such a request to provide additional information regarding the bookmark 222.

Referring back to FIG. 1, additionally or alternatively, at block 132, bookmark server 108 may prompt a user to see if a user would like to confirm or reject a particular bookmark in addition to or as an alternative to automatically generating such a bookmark, as described at block 116. For example, such a prompt may be utilized to permit a user to reject an automatically generated bookmark.

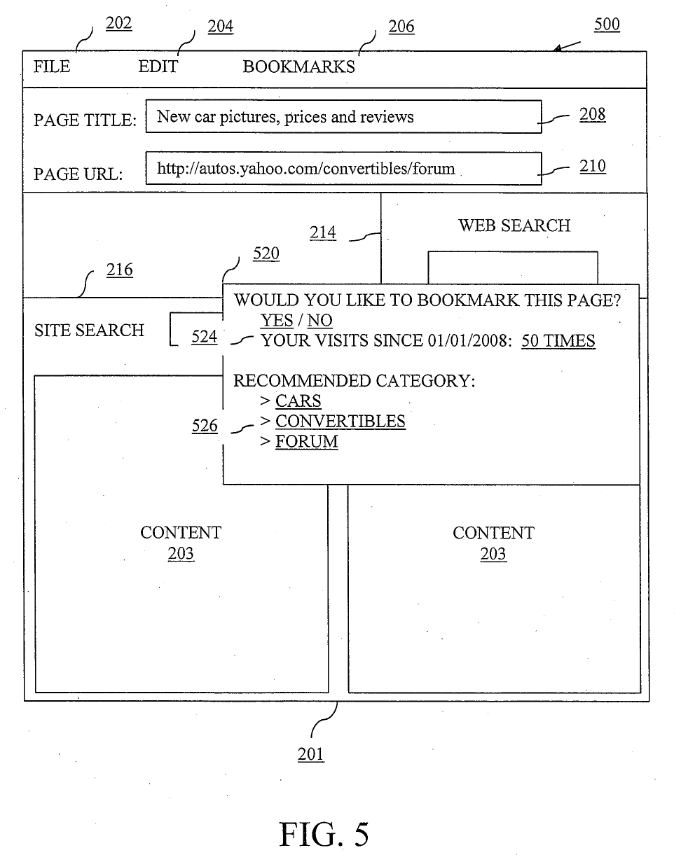

Referring to FIG. 5, a web browser display 500 is illustrated in accordance with one or more exemplary embodiments. In the example illustrated here, bookmark server 108 may prompt a user via a message 520 to see if a user would like to confirm or reject a particular automatically generated bookmark 222. In such a case, message 520 may include information 524 regarding the frequency of visits and/or the most recent visit may of a particular automatically generated bookmark 222 may be supplied along with such a request to provide additional information regarding the bookmark in question to a user. Additionally or alternatively, message 520 may request that the user select and/or confirm a category 526 and/or folder to associate with such an automatically generated bookmark.

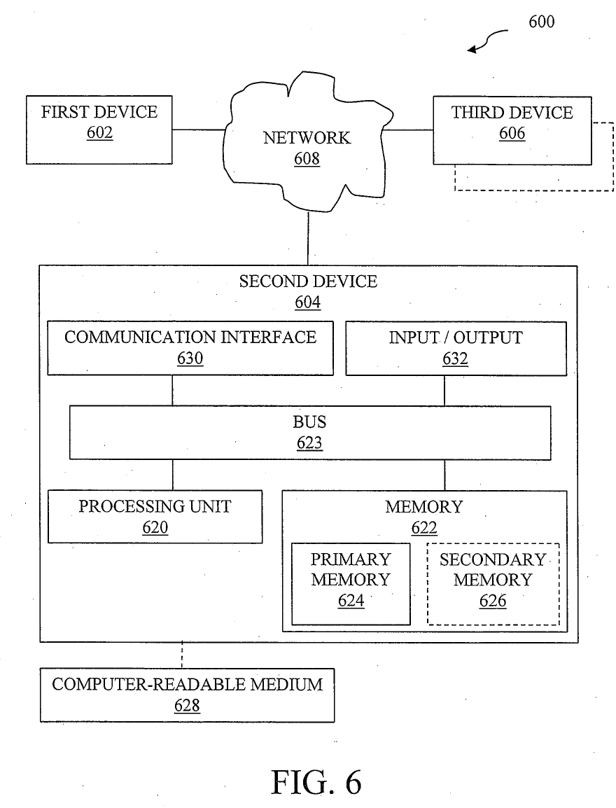

FIG. 6 is a block diagram illustrating an exemplary embodiment of a computing environment system 600 that may include one or more devices configurable automatically generating bookmarks associating user accounts with individual links based at least in part on tracked user access data. For example, computing environment system 600 may be operatively enabled to perform all or a portion of process 100 of FIG. 1.

Computing environment system 600 may include, for example, a first device 602, a second device 604 and a third device 606, which may be operatively coupled together through a network 608.

First device 602, second device 604 and third device 606, as shown in FIG. 6, are each representative of any device, appliance or machine that may be configurable to exchange data over network 608. By way of example, but not limitation, any of first device 602, second device 604, or third device 606 may include: one or more computing platforms or devices, such as, e.g., a desktop computer, a laptop computer, a workstation, a server device, storage units, or the like. A user may, for example, input a query and/or the like via first device 602.

In the context of this particular patent application, the term “special purpose computing platform” means or refers to a general purpose computing platform once it is programmed to perform particular functions pursuant to instructions from program software. By way of example, but not limitation, any of first device 602, second device 604, or third device 606 may include: one or more special purpose computing platforms once programmed to perform particular functions pursuant to instructions from program software. Such program software does not refer to software that may be written to perform process 100 of FIG. 1. Instead, such program software may refer to software that may be executing in addition to and/or in conjunction with all or a portion of process 100 of FIG. 1.

Network 608, as shown in FIG. 6, is representative of one or more communication links, processes, and/or resources configurable to support the exchange of data between at least two of first device 602, second device 604 and third device 606. By way of example, but not limitation, network 608 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated by the dashed lined box partially obscured behind third device 606, there may be additional like devices operatively coupled to network 608, for example.

It is recognized that all or part of the various devices and networks shown in system 600, and the processes and methods as further described herein, may be implemented using or otherwise include hardware, firmware, software, or any combination thereof.

Thus, by way of example, but not limitation, second device 604 may include at least one processing unit 620 that is operatively coupled to a memory 622 through a bus 623.

Processing unit 620 is representative of one or more circuits configurable to perform at least a portion of a data computing process or process. By way of example, but not limitation, processing unit 620 may include one or more processors, controllers, microprocessors, microcontrollers, application specific integrated circuits, digital signal processors, programmable logic devices, field programmable gate arrays, and the like, or any combination thereof.

Memory 622 is representative of any data storage mechanism. Memory 622 may include, for example, a primary memory 624 and/or a secondary memory 626. Primary memory 624 may include, for example, a random access memory, read only memory, etc. While illustrated in this example as being separate from processing unit 620, it should be understood that all or part of primary memory 624 may be provided within or otherwise co-located/coupled with processing unit 620.

Secondary memory 626 may include, for example, the same or similar type of memory as primary memory and/or one or more data storage devices or systems, such as, for example, a disk drive, an optical disc drive, a tape drive, a solid state memory drive, etc. In certain implementations, secondary memory 626 may be operatively receptive of, or otherwise configurable to couple to, a computer-readable medium 628. Computer-readable medium 628 may include, for example, any medium that can carry and/or make accessible data, code and/or instructions for one or more of the devices in system 600.

Second device 604 may include, for example, a communication interface 630 that provides for or otherwise supports the operative coupling of second device 604 to at least network 608. By way of example, but not limitation, communication interface 630 may include a network interface device or card, a modem, a router, a switch, a transceiver, and the like.

Second device 604 may include, for example, an input/output 632. Input/output 632 is representative of one or more devices or features that may be configurable to accept or otherwise introduce human and/or machine inputs, and/or one or more devices or features that may be configurable to deliver or otherwise provide for human and/or machine outputs. By way of example, but not limitation, input/output device 632 may include an operatively enabled display, speaker, keyboard, mouse, trackball, touch screen, data port, etc.

Some portions of the detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A method, comprising:
tracking, via a computing platform, user access data based at least in part on site visits and/or queries associated with a user account user account; and
automatically generating one or more bookmarks associating said user account with one or more links based at least in part on said tracked user access data, wherein said tracked user access data comprise frequency of visits.

2. The method of claim 1, further comprising:
receiving user access data comprising a current network location associated with said user account;
ranking one or more of said bookmarks based at least in part on said current network location; and
sending one or more of said bookmarks to said user account based at least in part on said ranking.

3. The method of claim 1, further comprising:
receiving user access data comprising a current network location associated with said user account;
ranking one or more of said bookmarks based at least in part on said current network location;
surfacing one or more of said bookmarks to said user account based at least in part on said ranking;
associating said user account with one or more additional links based at least in part on said tracked user access data, wherein said tracked user access data comprise recency of visits; and
surfacing one or more of said additional links to said user account based at least in part on said current network location.

4. The method of claim 1, further comprising:
receiving user access data comprising a current query associated with said user account;
ranking one or more of said bookmarks based at least in part on said current query; and
surfacing one or more of said bookmarks to said user account based at least in part on said ranking.

5. The method of claim 1, further comprising:
receiving user access data comprising a current query associated with said user account;
ranking one or more of said bookmarks based at least in part on said current query;
surfacing one or more of said bookmarks to said user account based at least in part on said ranking;
associating said user account with one or more additional links based at least in part on said tracked user access data, wherein said tracked user access data comprise recency of visits; and
surfacing one or more of said additional links to said user account based at least in part on said current query.

6. The method of claim 1, further comprising:
receiving user access data comprising a current network location associated with said user account and a current query associated with said user account;
ranking one or more of said bookmarks based at least in part on said current network location and said current query; and
surfacing one or more of said bookmarks to said user account based at least in part on said ranking.

7. The method of claim 1, further comprising:
receiving user access data comprising a current network location associated with said user account and a current query associated with said user account;
ranking one or more of said bookmarks based at least in part on said current network location and said current query;
surfacing one or more of said bookmarks to said user account based at least in part on said ranking;
associating said user account with one or more additional links based at least in part on said tracked user access data, wherein said tracked user access data comprise recency of visits; and
surfacing one or more of said additional links to said user account based at least in part on said current network location and said current query.

8. The method of claim 1, further comprising:
determining if an period of inactivity associated with one or more of said bookmarks has elapsed based at least in part on said tracked user access data; and
removing one or more of said bookmarks based at least in part on said determined period of inactivity.

9. The method of claim 1, further comprising:
determining if an period of inactivity associated with one or more of said bookmarks has elapsed based at least in part on said tracked user access data; and
surfacing a request for input to said user account regarding modification of one or more of said bookmarks based at least in part on said determined period of inactivity.

10. The method of claim 1, further comprising:
receiving user access data comprising a current network location associated with said user account and a current query associated with said user account;
ranking one or more of said bookmarks based at least in part on said current network location and said current query;
surfacing one or more of said bookmarks to said user account based at least in part on said ranking;
associating said user account with one or more additional links based at least in part on said tracked user access data, wherein said tracked user access data comprise recency of visits;
surfacing one or more of said additional links to said user account based at least in part on said current network location and said current query;
determining if an period of inactivity associated with one or more of said bookmarks has elapsed based at least in part on said tracked user access data; and
removing one or more of said bookmarks based at least in part on said determined period of inactivity.

11. An article comprising:
a storage medium comprising machine-readable instructions stored thereon, which, if executed by one or more processing units, operatively enable a computing platform to:
track user access data based at least in part on site visits and/or queries associated with an user account; and
automatically generate one or more bookmarks that associate user accounts with individual links based at least in part on said tracked user access data, wherein said tracked user access data comprise frequency of visits.

12. The article of claim 11, wherein said machine-readable instructions, if executed by the one or more processing units, operatively enable the computing platform to:
receive user access data comprising a current network location associated with said user account;
rank one or more of said bookmarks based at least in part on said current network location; and
surface one or more of said bookmarks to said user account based at least in part on said ranked bookmarks.

13. The article of claim 11, wherein said machine-readable instructions, if executed by the one or more processing units, operatively enable the computing platform to:
receive user access data comprising a current query associated with said user account;
rank one or more of said bookmarks based at least in part on said current query; and
surface one or more of said bookmarks to said user account based at least in part on said ranked bookmarks.

14. The article of claim 11, wherein said machine-readable instructions, if executed by the one or more processing units, operatively enable the computing platform to:
receive user access data comprising a current network location associated with said user account and a current query associated with said user account;
rank one or more of said bookmarks based at least in part on said current network location and said current query;
surface one or more of said bookmarks to said user account based at least in part on said ranked bookmarks;
associate said user account with one or more additional links based at least in part on said tracked user access data, wherein said tracked user access data comprise recency of visits; and
surface one or more of said additional links to said user account based at least in part on said current query.

15. The article of claim 11, wherein said machine-readable instructions, if executed by the one or more processing units, operatively enable the computing platform to:
determine if an period of inactivity associated with one or more of said bookmarks has elapsed based at least in part on said tracked user access data; and
remove one or more of said bookmarks based at least in part on said determined period of inactivity.

16. An apparatus comprising:
a computing platform, said computing platform being operatively enabled to:
track user access data based at least in part on site visits and/or queries associated with an user account; and
automatically generate one or more bookmarks that associate user accounts with individual links based at least in part on said tracked user access data, wherein said tracked user access data comprise frequency of visits.

17. The apparatus of claim 16, wherein said computing platform being further operatively enabled to:
receive user access data comprising a current network location associated with said user account;
rank one or more of said bookmarks based at least in part on said current network location; and
surface one or more of said bookmarks to said user account based at least in part on said ranked bookmarks.

18. The apparatus of claim 16, wherein said computing platform being further operatively enabled to:
receive user access data comprising a current query associated with said user account;
rank one or more of said bookmarks based at least in part on said current query; and
surface one or more of said bookmarks to said user account based at least in part on said ranked bookmarks.

19. The apparatus of claim 16, wherein said computing platform being further operatively enabled to:
receive user access data comprising a current network location associated with said user account and a current query associated with said user account;
rank one or more of said bookmarks based at least in part on said current network location and said current query;
surface one or more of said bookmarks to said user account based at least in part on said ranked bookmarks;
associate said user account with one or more additional links based at least in part on said tracked user access data, wherein said tracked user access data comprise recency of visits; and
surface one or more of said additional links to said user account based at least in part on said current query.

20. The apparatus of claim 16, wherein said computing platform being further operatively enabled to:
determine if an period of inactivity associated with one or more of said bookmarks has elapsed based at least in part on said tracked user access data; and
remove one or more of said bookmarks based at least in part on said determined period of inactivity.
